(19) United States
(12) Patent Application Publication
(10) Pub. No.: US 2017/0245007 A1
(43) Pub. Date: Aug. 24, 2017

(54) TELEVISION SYSTEM AND METHOD FOR PROMPTLY DISPLAYING INFORMATION ON TELEVISION SYSTEM

(71) Applicant: MStar Semiconductor, Inc., Hsinchu Hsien (TW)

(72) Inventor: Hung-Chi Huang, Hsinchu Hsien (TW)

(21) Appl. No.: 15/240,069

(22) Filed: Aug. 18, 2016

(30) Foreign Application Priority Data
Feb. 23, 2016 (TW) 105105331

(51) Int. Cl. H04N 21/443; H04N 21/654; G06F 9/44

(52) U.S. Cl. CPC H04N 21/4432; G06F 9/4406; G06F 9/4418; H04N 21/654; H04L 67/02

(57) ABSTRACT

A television system includes a storage unit, a system memory, a signal receiving unit, a display unit and a processing unit. The storage unit stores a plurality of program instructions, an informative image file and a kernel. The signal receiving unit receives a boot signal. The processing unit, coupled to the storage unit and the system memory, executes the program instructions to complete a step of performing one of a normal boot process and a fast boot process according to the boot signal. The step of performing the normal boot process includes loading the kernel to the system memory. The step of performing the fast boot process includes displaying the informative image file through the display unit without loading the kernel to the system memory.

This application claims the benefit of Taiwan application Serial No. 105105331, filed Feb. 23, 2016, the subject matter of which is incorporated herein by reference.

### BACKGROUND OF THE INVENTION

### Field of the Invention

The invention relates in general to a television system, and more particularly, to a television system for promptly displaying information and a method for promptly displaying information on a television system.

### Description of the Related Art

The main function of a conventional television is for watching television programs, and does not provide a function of browsing other information. Compared to a conventional television, apart from watching television programs, a smart television offers numerous additional functions, e.g., browsing various types of information on the Internet through a web browser, hence significantly enhancing the practicability of the television. A smart television is installed with an operating system. When the smart television is booted, a kernel of the operating system needs to be loaded to a system memory from a non-volatile memory using a bootloader, and is then executed by a processor. Further, as a smart television includes many hardware devices such as a video decoder, a network module and a display device that realize diversified functions, the boot process of the smart television also includes executing drivers of these hardware devices using the processor. All of the above reasons lead to a longer boot period compared to that of a conventional television. However, when a user needs to quickly browse certain information (e.g., the weather, stock price and news headlines), the user is required to wait for the smart television to complete the entire boot process before a browser application can be activated to display the desired information, in a way that time is inevitably wasted. Therefore, if the process of displaying information can be accelerated for a smart television, not only the application but also market competitiveness of a smart television can be enhanced.

### SUMMARY OF THE INVENTION

It is an object of the present invention to provide a television system for promptly displaying information and a method for promptly displaying information on a television system to reduce the time that a user needs to wait before obtaining desired information.

The present invention discloses a television system including a storage unit, a system memory, a signal receiving unit, a display unit and a processing unit. The storage unit stores a plurality of program instructions, an informative image file and a kernel. The signal receiving unit receives a boot signal. The processing unit, coupled to the storage unit and the system memory, executes the program instructions to complete a step of performing one of a normal boot process and a fast boot process according to the boot signal. The step of performing the normal boot process includes loading the kernel to the system memory. The fast boot process includes displaying the informative image file through the display unit without loading the kernel to the system memory.

The present invention further discloses a method for promptly displaying information on a television system. The television system a storage unit storing a plurality of program instructions, an informative image file and a kernel, a display unit, a system memory, and a signal receiving unit. The signal receiving unit receives a boot signal. The method includes performing one of a normal boot process and a fast boot process according to the boot signal. The step of performing the normal boot process includes loading the kernel to the system memory. The fast boot process includes displaying the informative image file through the display unit without loading the kernel to the system memory.

The television system is capable of displaying user desired information within a short period. Compared to a common smart television, the present invention performs a fast boot process to replace a normal boot process. In the fast boot process, the kernel is not loaded to the system memory of the television system, so as to prevent the time-consuming boot process from wasting too much time of the user.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a function block diagram of a television system according to an embodiment of the present invention;

FIG. 2 is a flowchart of an operating process of a television system of the present invention;

FIG. 3 is a schematic diagram of an informative image file of according to an embodiment of the present invention;

FIG. 4 is a schematic diagram of an informative image file of according to another embodiment of the present invention;

FIG. 5A and FIG. 5B are detailed flowcharts of steps of a displaying unit displaying an informative image file of the present invention.

### DETAILED DESCRIPTION OF THE INVENTION

The disclosure of the present invention includes a television system for promptly displaying information and a method for promptly displaying information on a television system to promptly display user desired information. In possible implementation, one person skilled in the art can realize the present invention by choosing equivalent elements or steps based on the disclosure of the application; that is, the implementation of the present invention is not limited to the non-limiting embodiments below.

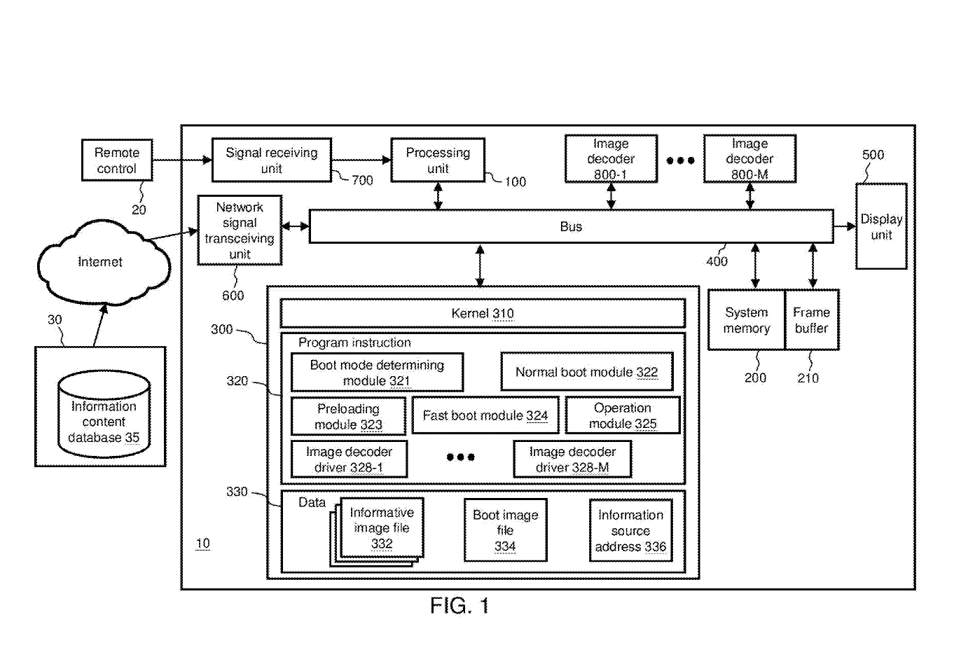

FIG. 1 shows a function block diagram of a television system according to an embodiment of the present invention. Referring to FIG. 1, a television system 10 includes a processing unit 100, a system memory 200, a storage unit 300, a system bus 400, a display unit 500, a network signal transceiving unit 600, a signal receiving unit 700, and an image decoder 800. In addition to a kernel 310 of the television system 10, the storage unit 300 further stores a program instruction 320 and data 330. The program instruction 320 may be divided into different function modules based on functions, and is executed by the processing unit 100 to realize its functions. For example but not limited to, the function modules include a boot mode determining module 321, a normal boot module 322, a preloading module 323, a fast boot module 324 and an operation module 325. The boot mode determining module 321 determines whether to perform a normal boot process or a fast boot process. The normal boot module 322 performs the normal boot process. The preloading module 323 captures information and generates an informative image file 332. The fast boot module 324 performs the fast boot process. The operation module 325 performs an informative image file selection operation after the fast boot process is completed. Image decoder drivers 328 respectively correspond to a plurality of image decoders 800 (image decoder driver 328-1 corresponding to image decoder 800-1, . . . , and image decoder driver 328-M corresponding to image decoder 800-M, where M is an integer), to allow the operating system of the television system 10 to access hardware resources of the image decoders 800. The data 330 includes the informative image file 332, a boot image file 334 and an information source address 336.

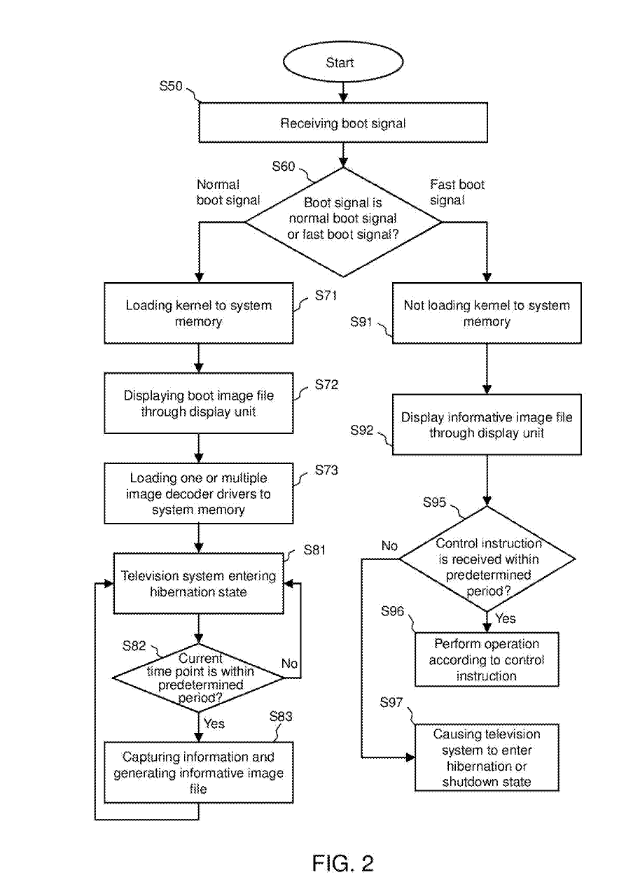

Referring to FIG. 2 showing a flowchart of a boot process of a television system of the present invention, details of how the television system 10 achieves the function of promptly browsing information of the present invention are described below. The television system 10 has a normal boot process and a fast boot process. The processing unit 100 receives a boot signal that a remote control 20 sends through the signal receiving unit 700 (step S50). The boot mode determining module 321 determines whether the boot signal is a normal boot signal or a fast boot signal (S60) to determine whether to perform one of a normal boot process and a fast boot process. For example, the normal boot signal is triggered by a power key of the remote control 20, and the fast boot signal is triggered by other keys, e.g., a fast information browsing key, a numerical key or other user-defined keys.

When the boot mode determining module 321 determines that the boot signal is a normal boot signal, the normal boot module 322 performs a normal boot process. In the embodiment, the normal boot process includes, but not limited to, steps S71, S72 and S73. In step S71, the normal boot module 322 loads the kernel 310 from the storage unit 300 to the system memory 200 via the system bus 400. In step S72, the normal boot module 322 stores the boot image file 334 to a frame buffer 210 in the system memory 200, so as to display the boot image file 334 through the display unit 500. In step S73, the image decoder driver 328 of the image decoder 800 is loaded to the system memory 200. In general, step S71 and S72 are completed through executing a loader by the processor 100. Because when the boot image file 334 in the frame buffer 210 is displayed through the display unit 500, the image decoder driver 328 of the image decoder 800 is not yet loaded to the system memory 200, the boot image file 334 is in an image file format that can be displayed without undergoing any decoding operation, e.g., a bitmap file. The boot file image 334 usually is not time-variant, e.g., a brand logo of the manufacturer of the television system 10. In the normal boot process of the television system 10, the display unit 500 continues displaying the boot image file 334 after it begins displaying the boot image file 334, till the normal boot process is completed. After the normal boot process is completed, the display unit 500 changes to display a user operation interface of the television system 10. It should be noted that, in this embodiment, the frame buffer 210 is a part of the system memory 200, both of which being the same physical memory (e.g., DRAM). In other embodiments, the frame buffer 210 and the system memory 200 may be different physical memories.

After the normal boot process is completed, the television system 10 enters a hibernation state after going through an idle period (step S81). In the hibernation state, the preloading module 323 determines whether the current time point is within a predetermined period (step S82). For example, the predetermined period is a period in which the television system 100 is less frequently used, e.g., a late night period. When the current time point is not within the predetermined period, the processing unit 100 stays in the hibernation state. When the current time point is within the predetermined period, the preloading module 323 causes the television system 10 to exit the hibernation state, but keeps the display unit 500 turned off (i.e., the television system 10 does not display any image), and starts capturing information to generate the informative image file 332 (step S83). More specifically, the preloading module 323 of the processing unit 100 controls the network signal transceiving unit 600 according to the information source address 336 to find a corresponding server 30, and captures data from an information content database 35 of the server 30. In one embodiment, the information source address 336 is an Internet Protocol (IP) address of the server 30, and the preloading module 323 captures the data by using a webpage browser. For example, the information source address 336 is an IP address of the sports website ESPN and points to a specific webpage (e.g., a webpage including scores of a recent game of the Major League), the preloading 323 may then capture original data of the webpage from the information content database 35 according to the HyperText Transfer Protocol (HTTP), converts the original data to a webpage, and converts the webpage to the informative image file 332. The informative image file 332 may be in a bitmap file format or other file formats.

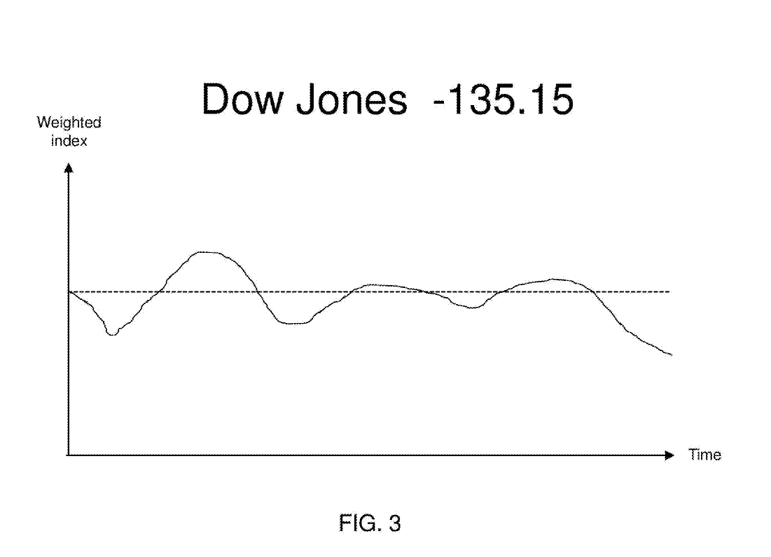

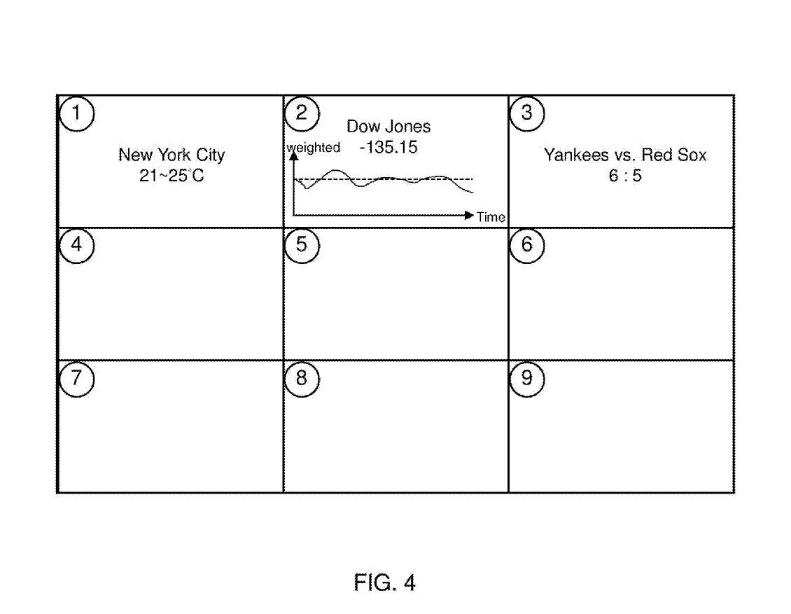

When the boot mode determining module 321 determines that the boot signal is the fast boot signal in step S60, the fast boot module 324 performs the fast boot process. In the embodiment, the fast boot process includes, but not limited to, steps S91 and S92. In the fast boot process, the television system 10 displays the informative image file 332 on the display unit 500 without needing to execute the operating system, and so the processing unit 100 does not load the kernel 310 to the system memory 200 (step S910). Next, the fast boot module 324 stores the informative image file 332 to the frame buffer 210 of the system memory 200 to display the informative image file 332 through the display unit 500 (step S92). Different from the boot image file 334, the informative image file 332 is time-variant. For example, as shown in FIG. 3, the informative image file 332 is a diagram of the stock trend of the weighted index of the most recent trading day of the stock market. In other embodiments, the informative image file 332 may be a single-type informative image file or multi-type informative image file. As shown in FIG. 3, a single-type informative image file shows one single type of information. Whereas, a multi-type informative image file includes a plurality of types of information. Taking FIG. 4 as an example, the multi-type informative image file consists of 9 sub-images, which show different types of information; for example, the sub-image 1 shows the weather, the sub-image 2 shows stock information, the sub-image 3 shows sports information, and so forth. The multi-type informative image file is formed by combining a plurality of single-type informative image files by the preloading module 323 of the processing unit 100 according to a factory setting or a user setting.

After the fast boot process is completed, the television system 10 enters a command waiting state. In the command waiting state, the operation module 325 determines whether a control instruction transmitted from the remote control 20 is received within a predetermined period (step S95). When the operation module 325 receives the control instruction within the predetermined period, the fast boot module 324 performs the corresponding operation according to the control instruction (step S96). Conversely, when the operation module 325 does not receive the control instruction within the predetermined period, the television system 10 is caused to enter the hibernation state or a shutdown state (step S97). Corresponding to different informative image files 332, the operation module 325 performs different operations in step S96. For example, as shown in FIG. 3, when the display unit 500 displays a single-type informative file (assuming the informative image file 332 includes two or more single-type informative files), the operation module 325 switches between these single-type informative image files according to the control instruction (e.g., corresponding to navigation buttons and direction keys on the remote control) to display different types of information through the display unit 500. When the display unit 500 displays a multi-type informative image file, as shown in FIG. 4, the operation module 325 selects the singe-type informative image file corresponding to a selected sub-image from the informative image file 332 according to the control command (e.g., corresponding to numerical keys and a direction keys on the remote control) and displays the selected single-type informative image file through the display unit 500. More specifically, assuming that the user presses the numerical key “2”, the operation module 325 stores the single-type informative image file corresponding to the sub-image 2 to the frame buffer 210 to replace the currently displayed multi-type informative image file, hence allowing the display unit 500 to display the informative image file 332 corresponding to the sub-image 2.

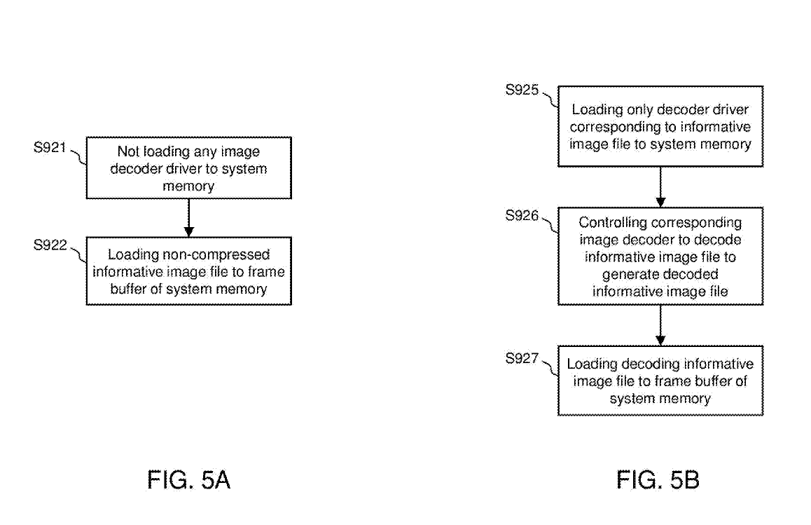

According to the file format of the informative image file 332 corresponding to a non-compressed format or a compressed format, step S92 may be divided into steps S921 to S922 (the informative image file 332 being a non-compressed format) in FIG. 5A, or steps S925 to S927 (the informative file 332 being a compressed format) in FIG. 5B. As a non-compressed image file can be directly displayed without any processing, when the informative image file 332 is in such file format (e.g., a BMP file format), the fast boot module 324 does not load any image decoder driver to the system memory 200 (step S921) and directly loads the informative image file 332 to the frame buffer 210 (S922). On the other hand, when the informative image file 332 is in a compressed format, e.g., a Joint Photographic Experts Group (JPEG) file format, the fast boot module 324 only loads the image decoder driver 800 that is associated with the JPEG file format to the system memory 200 (step S925), whereas the remaining image decoder drivers are not loaded, so as to control the image decoder 800 to decode the informative image file 332 to generate a decoded informative image file (step S926). Further, the fast boot module 324 stores the decoded informative image file to the frame buffer 210 (step S927) to display the informative image file 332 through the display unit 500. The above BMP file format and JPEG file format are examples for illustration purposes, and the informative image file 332 of the present invention is not limited to being in such file formats.

The hibernation state in step S81 and S97 refers to a state in which the processing unit 100 stores all data of the system memory 200 to the storage unit 300. Because the storage unit 300 is a non-volatile memory, the data originally in the system memory 200 is kept intact even if the television system 10 is no longer powered. When the television system 10 is powered on next time, the television system 10 may promptly restore to an operation state prior to the hibernation once the processing unit 100 relocates the data from the storage unit 300 to the system memory 200, hence eliminating the normal boot process. On the other hand, the shutdown state refers to a state in which the processing unit 100 performs the normal shutdown process of the operating system, stores certain permanently stored parameter settings or data to the storage unit 300, shuts down all applications and terminates all processes. The data originally stored in the system memory 200 after the shutdown is not kept, and the kernel and numerous hardware drivers need to be reloaded the next time the television system 100 is turned on, i.e., the normal boot process is performed.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A television system, comprising:
a storage unit, storing a plurality of program instructions, an informative image file and a kernel;
a system memory;
a signal receiving unit, receiving a boot signal;
a display unit; and
a processing unit, coupled to the storage unit and the system memory, executing the program instructions to complete a step of:
performing one of a normal boot process and a fast boot process according to the boot signal;
the step of performing the normal boot process comprising:
loading the kernel to the system memory; and
the step of performing the fast boot process comprising:
displaying the informative image file through the display unit without loading the kernel to the system memory.

2. The television system according to claim 1, further comprising one or multiple image decoders, wherein the storage unit further stores one or multiple image decoder drivers, the informative image file is a bitmap (BMP) file, the system memory comprises a frame buffer for storing a display image of the display unit, the step of performing the normal boot process further comprises:
loading the one or multiple image decoder drivers to the system memory; and
the step of performing the fast boot process further comprises:
loading the BMP file to the frame buffer of the system memory to serve as the display image of the display unit without loading any of the one or multiple image decoder drives to the system memory.

3. The television system according to claim 1, further comprising one or multiple image decoders, wherein the storage unit further stores one or multiple image decoder drivers, the one or multiple image decoders comprise a Joint Photographic Experts Group (JPEG) decoder, the one or multiple image decoder drivers comprise a JPEG decoder driver, the informative image file is a JPEG file, the system memory comprises a frame buffer for storing a display image of the display unit, the step of performing the normal boot process further comprises:
loading the one or multiple image decoder drivers to the system memory; and
the step of performing the fast boot process further comprises:
loading the JPEG decoder driver to the system memory but not the remaining image decoder drivers;
controlling the JPEG decoder to perform a decoding process on the JPEG file to generate a decoded informative image file; and
loading the decoded informative image file to the frame buffer of the system memory to serve as the display image of the display unit.

4. The television system according to claim 1, wherein the storage unit further stores a boot image file, and the step of performing the normal boot process further comprises:
displaying the boot image file through the display unit.

5. The television system according to claim 4, wherein the boot image file is different from the informative image file.

6. The television system according to claim 1, wherein the step of performing the normal boot process or the fast boot process according to the boot signal comprises:
determining whether the boot signal corresponds to a first input unit or a second input unit;
performing the normal boot process when the boot signal corresponds to the first input unit; and
performing the fast boot process when the boot signal corresponds to the second input unit.

7. The television system according to claim 1, further comprising:
a network signal transceiving unit, coupled to the processing unit;
wherein, when the television system is in a hibernation state, the display unit does not display any image, and the processing unit executes the program instructions to complete steps of:
receiving data from a server through the network signal transceiving unit; an
generating the informative image file according to the data.

8. The television system according to claim 7, wherein the step of generating the informative image file according to the data further comprises:
executing a web browser to generate a webpage corresponding to the server according to the data; and
converting the webpage to the informative image file.

9. The television system according to claim 1, wherein the informative image file comprises a first sub-image and a second sub-image, and information types of the first sub-image and the second sub-image are different.

10. The television system according to claim 1, wherein after the step of the fast boot process is completed, the processing unit further executes the program instructions to complete steps of:
entering a command waiting state;
determining whether the command waiting state exceeds a predetermined period; and
when the command waiting state exceeds the predetermined period, causing the television system to enter a hibernation state or a shutdown state.

11. A method for promptly displaying information on a television system, the television system comprising a storage unit storing a plurality of program instructions, an informative image file, and a kernel, a display unit, a system memory and a signal receiving unit for receiving a boot signal, the method comprising:
performing one of normal boot process and a fast boot process according to the boot signal;
the step of performing the normal boot process comprising:
loading the kernel to the system memory; and
the step of performing the fast boot process comprising:
displaying the informative image file through the display unit without loading the kernel to the system memory.

12. The method according to claim 11, wherein the television system further comprises one or multiple image decoders, the storage further stores one or multiple image decoder drivers, the informative image file is a bitmap (BMP) file, the system memory comprises a frame buffer for storing a display image of the display unit, the step of performing the normal boot process further comprises:
loading the one or multiple image decoder drivers to the system memory; and
the step of performing the fast boot process further comprises:
loading the BMP file to the frame buffer of the system memory to serve as the display image of the display unit without loading any of the one or multiple image decoder drives to the system memory.

13. The method according to claim 11, wherein the television system further comprises one or multiple image decoders, the storage unit further stores one or multiple image decoder drivers, the one or multiple image decoders comprise a Joint Photographic Experts Group (JPEG) decoder, the one or multiple image decoder drivers comprise a JPEG decoder driver, the informative image file is a JPEG file, the system memory comprises a frame buffer for storing a display image of the display unit, the step of performing the normal boot process further comprises:
loading the one or multiple image decoder drivers to the system memory; and
the step of performing the fast boot process further comprises:
loading the JPEG decoder driver to the system memory but not the remaining image decoder drivers;
controlling the JPEG decoder to perform a decoding process on the JPEG file to generate a decoded informative image file; and
loading the decoded informative image file to the frame buffer of the system memory to serve as the display image of the display unit.

14. The method according to claim 11, wherein the storage unit further stores a boot image file, and the step of performing the normal boot process further comprises:
displaying the boot image file through the display unit.

15. The method according to claim 14, wherein the boot image file is different from the informative image file.

16. The method according to claim 11, wherein the step of performing the normal boot process or the fast boot process according to the boot signal comprises:
determining whether the boot signal corresponds to a first input unit or a second input unit;
performing the normal boot process when the boot signal corresponds to the first input unit; and
performing the fast boot process when the boot signal corresponds to the second input unit.

17. The method according to claim 11, wherein the television system further comprises a network signal transceiving unit, when the television system is in a hibernation state, the display unit does not display any image, the method further comprising:
receiving data from a server through the network signal transceiving unit in the hibernation state; and
generating the informative image file according to the data in the hibernation state.

18. The method according to claim 17, wherein the step of generating the informative image file according to the data further comprises:
executing a web browser to generate a webpage corresponding to the server according to the data; and
converting the webpage to the informative image file.

19. The method according to claim 11, wherein the informative image file comprises a first sub-image and a second sub-image, and information types of the first sub-image and the second sub-image are different.

20. The method according to claim 11, after the fast boot process is performed, the method further comprising:
causing the television system to enter an command waiting state;
determining whether the command waiting state exceeds a predetermined period; and
when the command waiting state exceeds the predetermined period, causing the television system to enter a hibernation state or a shutdown state.
